(19) United States
(12) Patent Application Publication
(10) Pub. No.: US 2015/0160883 A1
(43) Pub. Date: Jun. 11, 2015

(54) STORAGE CONTROLLER, STORAGE APPARATUS, AND COMPUTER-READABLE STORAGE MEDIUM STORING STORAGE CONTROL PROGRAM

(71) Applicant: FUJITSU LIMITED, Kawasaki-shi (JP)

(72) Inventors: Atsushi IGASHIRA, Yokohama (JP); Toshio Iga, Kawasaki (JP)

(73) Assignee: FUJITSU LIMITED, Kawasaki-shi (JP)

(21) Appl. No.: 14/540,732

(22) Filed: Nov. 13, 2014

(30) Foreign Application Priority Data
Dec. 6, 2013 (JP) 2013-253525

(51) Int. Cl. G06F 3/06

(52) U.S. Cl. CPC G06F 3/0626; G06F 3/0689; G06F 3/0665

(57) ABSTRACT

A DE-DISK-TBL in a CMT stores configuration information on a storage apparatus, and an acquisition unit acquires information on connected DEs and disk devices and stores the information in an ENCMAP. Then, a member notification unit acquires DE-Nos from the DE-DISK-TBL by using as a search key the information on the disk devices stored in the ENCMAP. A class notification unit acquires DE-Nos from the DE-DISK-TBL by using as a search key the information about the DEs stored in the ENCMAP. Then, an integration unit determines the DE-Nos of the connected DEs on the basis of the DE-Nos acquired by the member notification unit and the class notification unit. A check unit determines whether there is an incorrect cable connection on the basis of the DE-Nos determined by the integration unit.

### CROSS-REFERENCE TO RELATED APPLICATION(S)

This application is based upon and claims the benefit of priority of the prior Japanese Patent Application No. 2013-253525, filed on Dec. 6, 2013, the entire contents of which are incorporated herein by reference.

### FIELD

The embodiment discussed herein is directed to a storage controller, a storage apparatus, and a computer-readable storage medium storing a storage control program.

### BACKGROUND

A storage apparatus includes a controller enclosure that houses a controller for controlling the storage apparatus, and a plurality of disk enclosures that house storage media. FIG. 25 illustrates one example of the configuration of a storage apparatus. As illustrated in FIG. 25, a storage apparatus 90 is composed of a controller enclosure 91 and n disk enclosures 92.

The controller enclosure 91 is cable-connected to one disk enclosure 92, and the disk enclosure 92 cable-connected to the controller enclosure 91 is cable-connected to other disk enclosures 92 in cascade. The cable connection is duplexed.

At the time when the storage apparatus 90 is turned on or at other times, the controller checks whether the cable connection is properly established. For example, the controller acquires device information from the disk enclosures 92 in connection order via each of the duplexed cable connections. The controller then checks whether or not the connection order of the disk enclosures 92 obtained via one cable connection is identical to the connection order of the disk enclosures 92 obtained via the other cable connection. When two connection orders are different from each other, the controller determines that there is an incorrect cable connection (see, for example, Japanese Laid-open Patent Publication No. 2009-181317).

For example, one controller, out of two controllers, acquires device information from the respective disk enclosures 92 via one cable connection and registers the device information in a shared memory. Then, the other controller, out of two controllers, acquires device information from the respective disk enclosures 92 via the other cable connection, and collates the acquired device information with the information in the shared memory, so as to check incorrect cable connection (see, for example, Japanese Laid-open Patent Publication No. 2006-146489).

However, the method of collating the connection orders in the duplexed cable connections and detecting incorrect connection has a problem in which it is difficult to correctly detect the incorrect connection. For example, when both the duplexed cable connections are incorrectly connected, the incorrect connection is not detected by collation of these connections.

### SUMMARY

According to an aspect of an embodiment, a storage controller controlling a plurality of enclosures connected in cascade includes a memory that stores information that defines the enclosures; and a processor that acquires information on the connected enclosures from the enclosures, identifies connected storage devices on the basis of the acquired information and the information stored in the memory, and determines whether or not the identified enclosures are correctly connected on the basis of a connection order of the enclosures.

### BRIEF DESCRIPTION OF DRAWINGS

FIG. 1 is a configuration view illustrating a storage apparatus according to an embodiment;

FIG. 2 illustrates disk enclosures (DEs) connected in cascade;

FIG. 3 illustrates the configuration of a DE;

FIG. 4 illustrates the configuration of a storage control unit;

FIG. 5 illustrates a table region;

FIG. 6 illustrates a cable connection configuration;

FIG. 7A illustrates one example of connection configurations I and II;

FIG. 7B is an explanatory view illustrating an advantage of the connection configuration II;

FIG. 8 illustrates one example of a DE-DISK-TBL;

FIG. 9A illustrates one example of an ENCMAP;

FIG. 9B illustrates one example of the ENCMAP;

FIG. 10 illustrates DE-No determination patterns;

FIG. 11 illustrates rules of DE-No determination patterns;

FIG. 12A illustrates the ENCMAP after DE-No determination;

FIG. 12B illustrates the ENCMAP after DE-No determination;

FIG. 13A illustrates the ENCMAP after DE-Status determination;

FIG. 13B illustrates the ENCMAP after DE-Status determination;

FIG. 14A illustrates one example of DE-Status determination results;

FIG. 14B illustrates one example of DE-Status determination results;

FIG. 15A illustrates examples of apparatus status determination;

FIG. 15B illustrates examples of apparatus status determination;

FIG. 16 is a flow chart illustrating a flow of apparatus status determination processing performed by the control unit;

FIG. 17 is a flow chart illustrating the details of the processing in steps S2 to S5 illustrated in FIG. 16;

FIG. 18 is a flow chart illustrating a flow of processing to acquire a DE-No from information on disk devices;

FIG. 19 is a flow chart illustrating a flow of processing to acquire a DE-No from DE information;

FIG. 20A is a flow chart illustrating a flow of connection check processing;

FIG. 20B is a flow chart illustrating a flow of connection check processing;

FIG. 21 is a flow chart illustrating a flow of IOM separation processing;

FIG. 22 illustrates a problem in a conventional connection check;

FIG. 23 is a flow chart illustrating a flow of processing of active increase and decrease of DEs;

FIG. 24 illustrates a hardware configuration of the storage control unit; and

FIG. 25 illustrates one example of the configuration of the storage apparatus.

### DESCRIPTION OF EMBODIMENT

A preferred embodiment of the present invention will be explained with reference to accompanying drawings. It is to be noted that the embodiment is not intended to limit the disclosed technology.

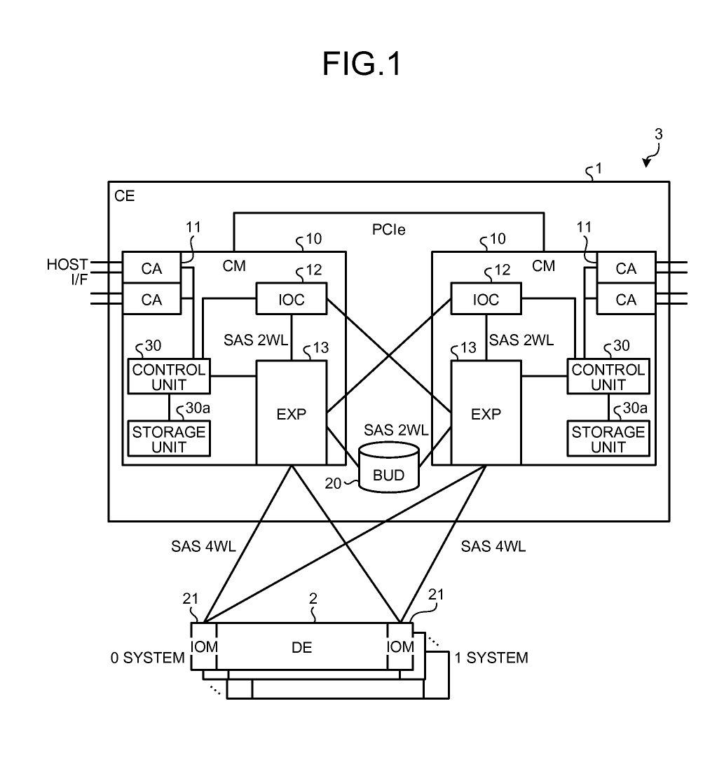

First, the configuration of a storage apparatus according to an embodiment will be described. FIG. 1 is a configuration view illustrating the storage apparatus according to the embodiment. As illustrated in FIG. 1, a storage apparatus 3 includes a controller enclosure (CE) 1 and 13 disk enclosures (DEs) 2. Although the storage apparatus 3 which houses 13 DEs is described herein, the storage apparatus 3 may also house an arbitrary number of DEs 2.

The CE 1 is connected to one DE 2 via a serial attached SCSI (SAS) cable, and the DE 2, which is cable-connected to the CE 1, is connected to other DEs 2 in cascade via the SAS cable. The SAS cable supports a 4-wide link (4WL) made up of four physical links used as one logical link.

The SAS cable connection is duplexed to provide two cable connections of 0 system and 1 system. The 0 system provides straight connection, while the 1 system provides reverse connection. For example, when 13 DEs from DE#01 to DE#13 are connected in order of CE1→DE#01→DE#02→ . . . →DE#13, this connection is referred to as a straight connection, while the connection in order of CE1→DE#13→DE#12→ . . . →DE#01 is referred to as a reverse connection.

The CE 1 includes a controller module (CM) 10 that controls the storage apparatus 3, and a bootup and utility device (BUD) 20 that stores configuration information on components, such as the DEs 2 included in the storage apparatus 3. The CM 10 is duplexed into two CMs 10, which are connected through a PCI express (PCIe).

Each of the CMs 10 includes two channel adapters (CAs) 11, an input output controller (IOC) 12, an expander (EXP) 13, a control unit 30, and a storage unit 30a. The CA 11 is an interface with a host, such as a server which uses the storage apparatus 3. The IOC 12 controls the DEs 2 via the EXP 13. The EXP 13 is a SAS interface to connect between the CM 10 and the DEs 2. The control unit 30 controls the CA 11, the IOC 12, and the EXP 13 to control the storage apparatus 3. The storage unit 30a stores programs and data used by the control unit 30.

The DE 2 is a storage device that houses 60 disk devices. The DE 2 has two input output modules (IOMs) 21 in the enclosure. The IOM 21 is an input/output interface used for connection with the CE 1 or other DEs 2. One of two IOMs 21 is used for connection in the 0 system, while the other is used for connection in the 1 system. Although a description will be given of the DE 2 that houses 60 disk devices here, a DE 2 that houses an arbitrary number of disk devices may also be employed.

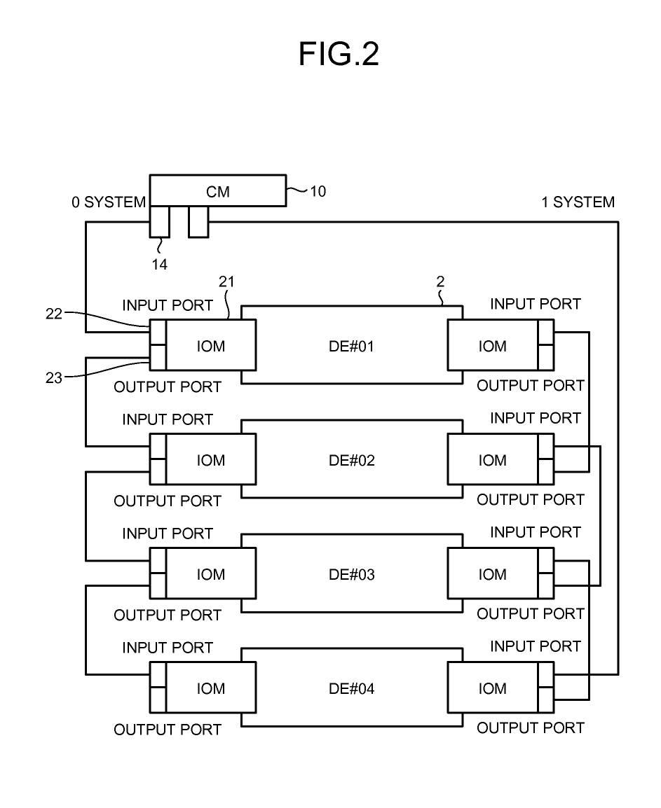

FIG. 2 illustrates the DEs 2 connected in cascade. FIG. 2 illustrates the case where the CM 10 is cascade-connected with four DEs 2 for the purpose of illustration. Four DEs 2 are expressed by DE#01 to DE#04. The 0 system has a straight connection, while the 1 system has a reverse connection. Each of the IOMs 21 has an input port 22 and an output port 23.

As illustrated in FIG. 2, in the 0 system, an output port 14 of the CE 1 is cable-connected to the input port 22 of the IOM 21 included in the DE#01, and the output port 23 of the IOM 21 included in the DE#01 is cable-connected to the input port 22 of the IOM 21 included in the DE#02. The output port 23 of the IOM 21 included in the DE#02 is also cable-connected to the input port 22 of the IOM 21 included in the DE#03, and the output port 23 of the IOM 21 included in the DE#03 is cable-connected to the input port 22 of the IOM 21 included in the DE#04.

In the 1 system, the output port 14 of the CE 1 is cable-connected to the input port 22 of the IOM 21 included in the DE#04, and the output port 23 of the IOM 21 included in the DE#04 is cable-connected to the input port 22 of the IOM 21 included in the DE#03. The output port 23 of the IOM 21 included in the DE#03 is also cable-connected to the input port 22 of the IOM 21 included in the DE#02, and the output port 23 of the IOM 21 included in the DE#02 is cable-connected to the input port 22 of the IOM 21 included in the DE#01.

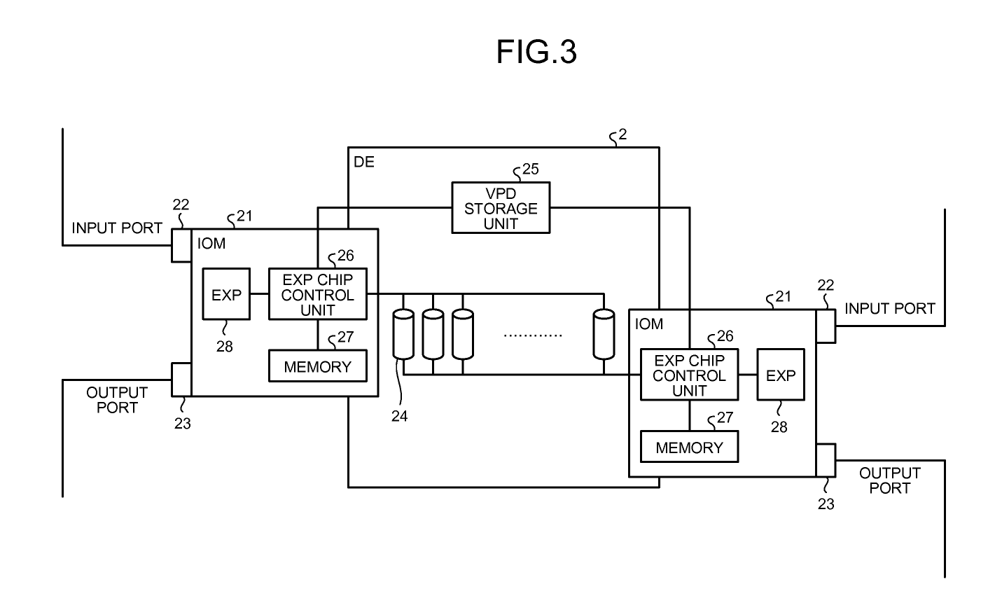

FIG. 3 illustrates the configuration of a DE 2. As illustrated in FIG. 3, the DE 2 has two IOMs 21 and 64 disk devices 24, and a vital product data (VPD) storage unit 25.

The disk device 24 is a storage device that stores data. The disk device 24 has information, such as a world wide name (WWN) that identifies the device, and a capacity, as device information. The VPD storage unit 25 stores information on the DE 2, such as a WWN and a device type.

The IOM 21 includes an EXP chip control unit 26, a memory 27, and an EXP 28. The EXP chip control unit 26 controls the EXP 28. The EXP chip control unit 26 acquires information, such as the WWN, from the disk device 24 or the VPD storage unit 25 on the basis of a request from the CE 1, and transmits the acquired information to the CE 1. The memory 27 stores information such as the WWN, which has been acquired from the disk device 24 or the VPD storage unit 25 by the EXP chip control unit 26. The EXP 13 is a SAS interface.

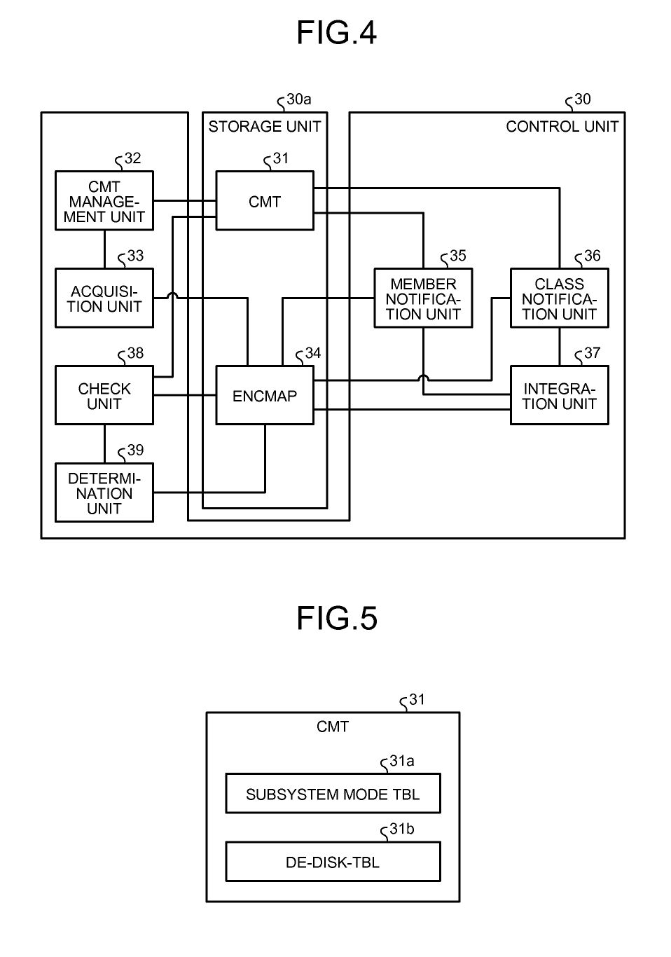

Next, the configuration of the control unit 30 and the storage unit 30a illustrated in FIG. 1 will be described. Here, the control unit 30 and the storage unit 30a are collectively referred to as a storage control unit. FIG. 4 illustrates the configuration of the storage control unit. As illustrated in FIG. 4, the control unit 30 includes a CMT management unit 32, an acquisition unit 33, a member notification unit 35, a class notification unit 36, an integration unit 37, a check unit 38, and a determination unit 39.

The storage unit 30a stores various programs, management information, and the like. The storage unit 30a includes a table region (CMT) that stores configuration information and the like read out from the BUD 20, and a table region (ENCMAP) that stores information on the DEs 2 and the disk devices 24 connected to the CE 1. FIG. 5 illustrates the table region (CMT). As illustrated in FIG. 5, a CMT 31 includes a subsystem mode TBL 31a and a DE-DISK-TBL 31b.

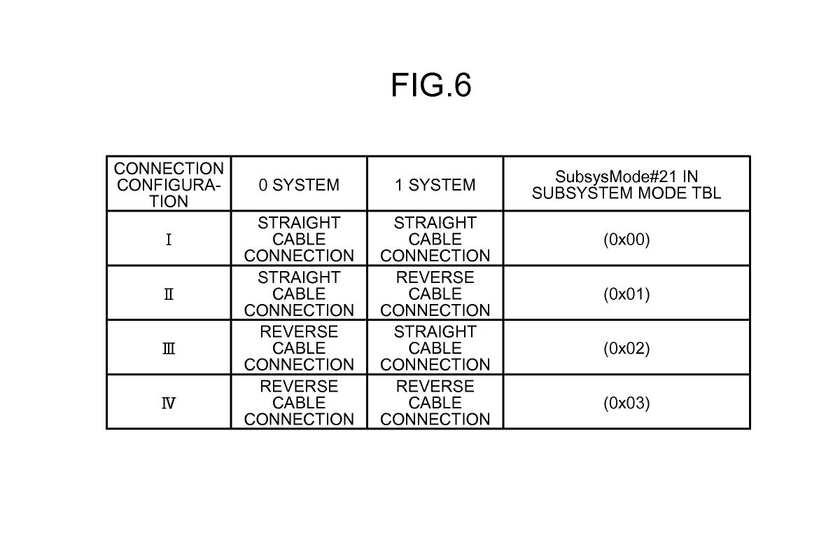

The subsystem mode TBL 31a is a table region which stores information such as an apparatus model and type of the storage apparatus 3. The subsystem mode TBL 31a is also a table region which stores information on cable connection configuration. FIG. 6 illustrates the cable connection configuration. As illustrated in FIG. 6, there are four connection configurations I to IV depending on whether the 0 system and the 1 system are connected in a straight direction (forward direction) or in a reverse direction (backward direction). The information on the connection configuration is stored in a 1-byte area called SubsysMode#21 in the subsystem mode TBL 31a.

The connection configuration I is adopted in the case where the 0 system and the 1 system have straight cable connection. In this case, “00” is stored in hexadecimal in the SubsysMode#21. An expression “0x” indicates a hexadecimal value. The connection configuration II is adopted in the case where the 0 system has straight cable connection and the 1 system has reverse cable connection. In this case, “01” is stored in hexadecimal in the SubsysMode#21. The connection configuration III is adopted in the case where the 0 system has reverse cable connection and the 1 system has straight cable connection. In this case, “02” is stored in hexadecimal in the SubsysMode#21. The connection configuration IV is adopted in the case where the 0 system and the 1 system have reverse cable connection. In this case, “03” is stored in hexadecimal in the SubsysMode#21.

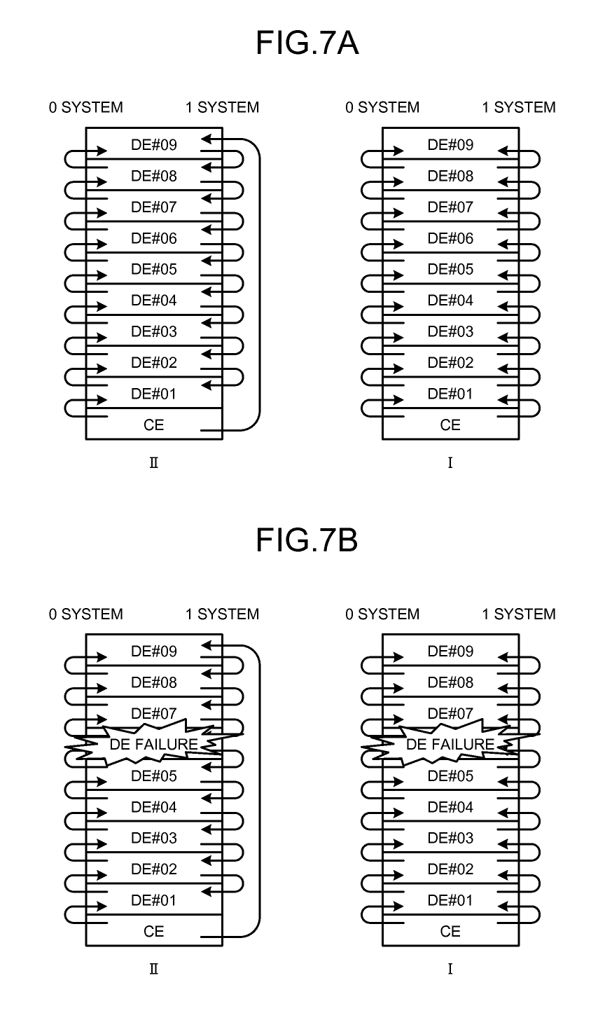

FIG. 7A illustrates one example of the connection configurations I and II. As illustrated in FIG. 7A, in the connection configuration I, the CE 1 and nine DEs 2 have straight cable connection in both the 0 system and the 1 system. In the connection configuration II, the CE 1 and nine DEs 2 have straight cable connection in the 0 system and have reverse cable connection in the 1 system.

FIG. 7B is an explanatory view illustrating an advantage of the connection configuration II. As illustrated in FIG. 7B, when a failure occurs in the DE#06 positioned in the middle in the connection configuration I, there is no access path to the DE#07 to DE#09. Contrary to this, in the connection configuration II, even when a failure occurs in the DE#06 positioned in the middle, an access path to the DE#01 to DE#05 is secured by the 0 system and an access path to the DE#07 to DE#09 is secured by the 1 system. Thus, in the connection configuration II, even when one of the cascade-connected DEs 2 fails, the access path to other DEs 2 is secured.

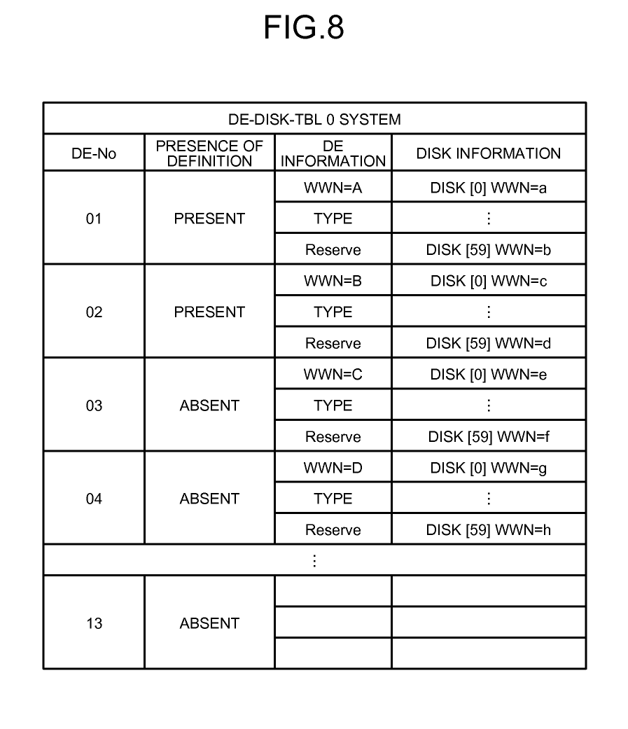

Referring again to FIG. 5, the DE-DISK-TBL 31b is a table which stores configuration information on the storage apparatus 3 based on a predefined connection rule. Here, the term “connection rule” refers to a connection order of the DEs 2. FIG. 8 illustrates one example of the DE-DISK-TBL 31b.

As illustrated in FIG. 8, the DE-DISK-TBL 31b stores DE-No, presence of definition, DE information (disk enclosure information), and DISK information. The DE-No (disk enclosure number) is an identification number which identifies each DE 2. The presence of definition indicates whether a DE 2 is present or absent. When the DE 2 is present but is not managed in the storage apparatus 3, the DE 2 is defined as “absent.” The DE information indicates the WWN and the type of a DE 2. The type represents classification based on the number of the disk devices 24 housed in the DE 2. “Reserve” indicates that a certain area is reserved for expansion.

The DISK information indicates WWNs of 60 disk devices 24. For example, the DE 2 with an identification number “01” has a WWN of “A,” and its 1st disk device 24 has a WWN of “a,” and its 60th disk device 24 has a WWN of “b.”

As illustrated in FIG. 8, according to the predefined connection rule, the DEs 2 are connected in order of “01”→“02”→ . . . →“13”, i.e., in ascending order of DE-Nos. Thus, since the DEs 2 are connected in ascending order of DE-Nos according to the predefined connection rule, the control unit 30 can determine whether there is an incorrect cable connection by checking the order of DE-Nos.

Referring again to FIG. 4, the CMT management unit 32 manages the CMT 31. For example, the CMT management unit 32 reads out configuration information and the like from the BUD 20, and stores the information in the CMT 31.

The acquisition unit 33 acquires the information on the DEs 2 and the disk devices 24 which are connected to the CE 1, from the DEs 2 in connection order, and stores the information in a ENCMAP 34. Once a DE 2 receives an information acquiring request from the acquisition unit 33, the EXP chip control unit 26 of the IOM 21 reads out information on the DE 2 and the disk devices 24 from the memory 27, and transmits the information to the CE 1.

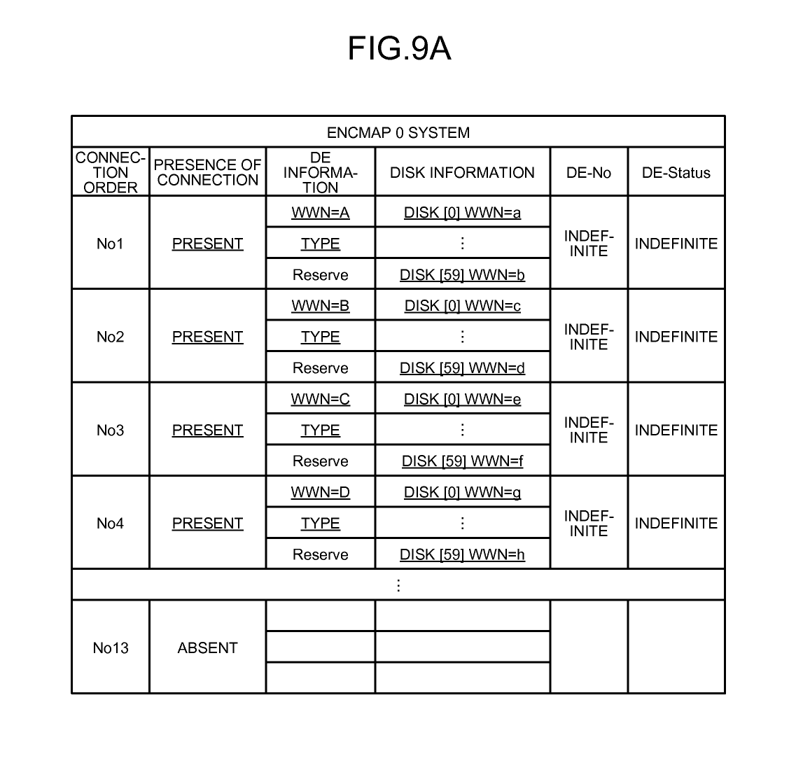

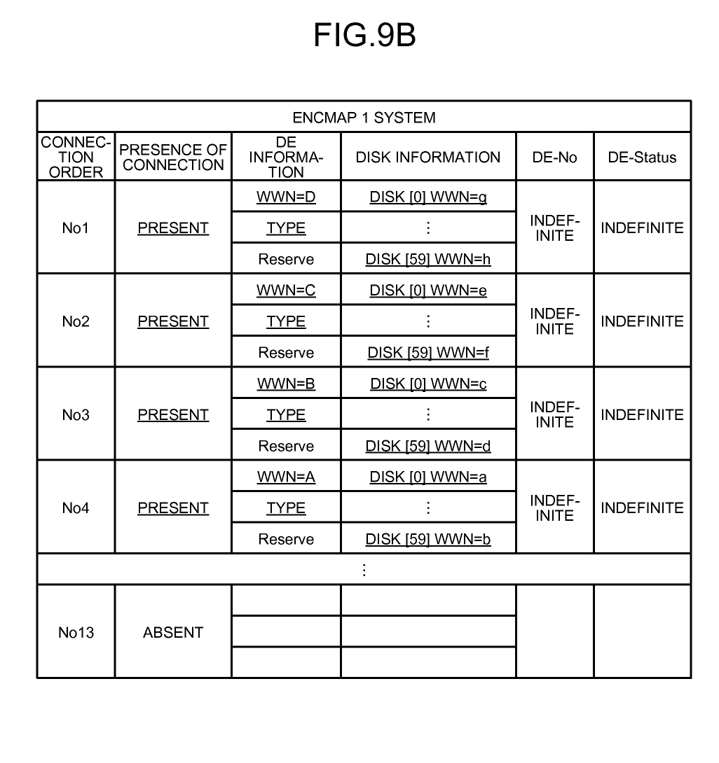

The ENCMAP 34 is a table region that stores the information on the DEs 2 and the disk devices 24 acquired by the acquisition unit 33 in order of acquisition. FIGS. 9A and 9B illustrate one example of the ENCMAP 34. FIG. 9A illustrates the case of straight cable connection configuration, while FIG. 9B illustrates the case of reverse cable connection configuration.

As illustrated in FIGS. 9A and 9B, the ENCMAP 34 stores a connection order, presence of connection, DE information, DISK information, DE-No, and DE-Status. The connection order represents an order of connection to the CE 1. The connection order is acquired by the acquisition unit 33. The presence of connection represents the presence or absence of connected DEs. The DE information is the information on the DEs 2 acquired by the acquisition unit 33, the information including the WWNs and the types of the DEs 2. The DISK information is information on the disk devices 24 acquired by the acquisition unit 33, the information including WWNs of the disk devices 24. The DE-No is the number to identify each DE 2. The DE-Status represents the status of each DE 2.

As illustrated in FIG. 9A, in the straight cable connection configuration, the DEs 2 are connected from the CE 1 in order of DE 2 whose WWW is “A”→DE 2 whose WWW is “B”→DE 2 whose WWW is “C”→DE 2 whose WWW is “D.” As illustrated in FIG. 9B, in the reverse cable connection configuration, the DEs 2 are connected from the CE 1 in order of DE 2 whose WWW is “D”→DE 2 whose WWW is “C”→DE 2 whose WWW is “B”→DE 2 whose WWW is “A.”

When the acquisition unit 33 acquires information from the connected DEs 2, the presence of connection, the DE information, and the DISK information are stored in the ENCMAP 34. In FIGS. 9A and 9B, information acquired by the acquisition unit 33 is underlined.

The member notification unit 35 searches the DE-DISK-TBL 31b by using as a search key the information on the disk devices 24 included in each DE 2 stored in the ENCMAP 34, and notifies the integration unit 37 of the DE-Nos of the DEs 2, which are matched with the search key, as a search result. Here, the information on the disk devices 24 included in each DE 2 is specifically the WWNs of all the disk devices 24 included in each DE 2, and the search key is a plurality of WWNs.

The class notification unit 36 searches the DE-DISK-TBL 31b by using as a search key the information on each DE 2 stored in the ENCMAP 34, i.e., the WWW and the type of each DE 2, and notifies the integration unit 37 of the DE-Nos of the DEs 2 which are matched with the search key, as a search result.

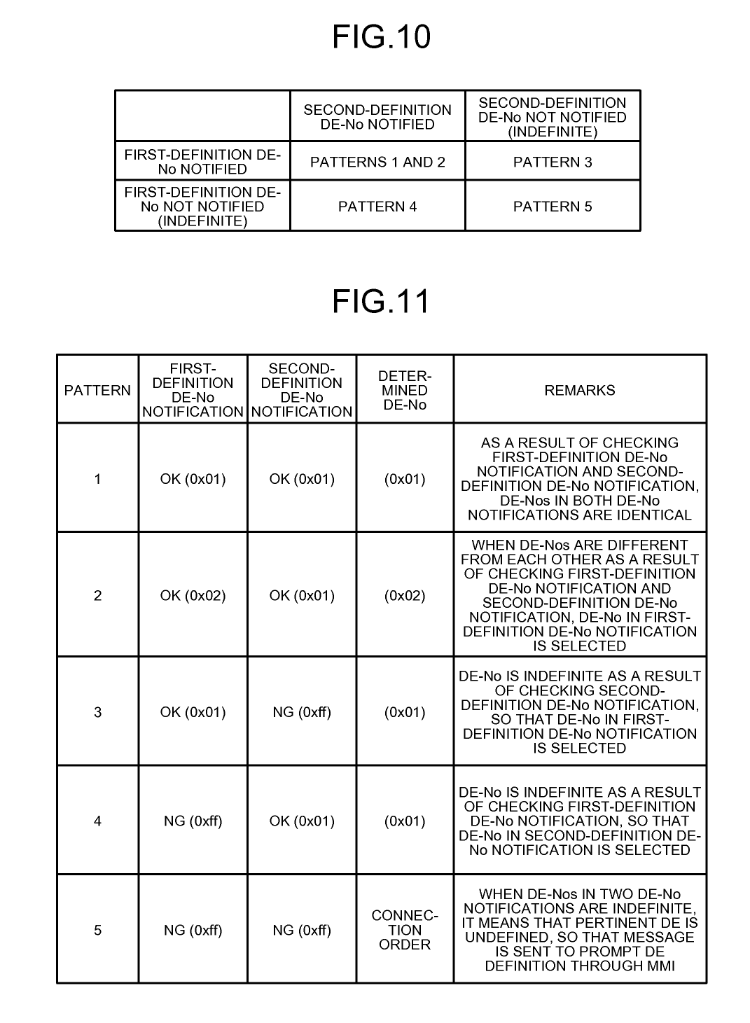

The integration unit 37 determines the DE-No of each DE 2 stored in the ENCMAP 34 on the basis of the DE-Nos notified from the member notification unit 35 and the DE-Nos notified from the class notification unit 36. FIG. 10 illustrates DE-No determination patterns. In FIG. 10, first-definition DE-No notification is notification of DE-No notified from the member notification unit 35, while second-definition DE-No notification is notification of DE-No from the class notification unit 36.

As illustrated in FIG. 10, five determination patterns are provided depending on the combination of the presence/absence of the notification of first-definition DE-No, and the notification of second-definition DE-No. When the first-definition DE-No and the second-definition DE-No are notified, patterns 1 and 2 are used for determination. The pattern 1 is used in the case where two DE-Nos are matched. The pattern 2 is used in the case where two DE-Nos are not matched. When the first-definition DE-No is notified but the second-definition DE-No is not notified, a pattern 3 is used for determination. When the first definition DE-No is not notified but the second-definition DE-No is notified, a pattern 4 is used for determination. When both the first-definition DE-No and the second-definition DE-No are not notified, a pattern 5 is used for determination. The DE-No not notified indicates that a value to be notified by DE-No notification is indefinite.

FIG. 11 illustrates rules of DE-No determination patterns. In FIG. 11, “OK” indicates that DE-No is retrieved, while “NG” indicates that DE-No is not retrieved. The numeric characters in brackets are examples of the notified DE-No and determined DE-No expressed in hexadecimal.

As illustrated in FIG. 11, in the pattern 1, the first-definition DE-No and the second-definition DE-No are notified, and both the values are identical. Therefore, the integration unit 37 determines the identical value as the DE-No. For example, when the DE-No notified by the first-definition DE-No notification and the second-definition DE-No notification is “0x01,” the DE-No is determined to be “0x01.”

In the pattern 2, the first-definition DE-No and the second-definition DE-No are notified, and their values are different from each other. Accordingly, the integration unit 37 needs to select one of the values, so that the value by the first-definition DE-No notification is determined as the DE-No. In other words, the integration unit 37 gives priority to the first-definition DE-No notification over the second-definition DE-No notification. This is because the disk devices 24 store important data of a user, and unapproved replacement and/or movement of the disk devices 24 without going through formal procedures is never performed. While unapproved replacement and/or movement of the DEs 2 without going through formal procedures is also never performed, the DEs 2 are merely outer frame boxes for mounting the disk devices 24. Therefore, if unapproved replacement and/or movement of the DEs 2 is conducted, it does not pose a major problem unless replacement and/or movement of the disk devices 24 is involved. For example, when the DE-No notified by the first-definition DE-No notification is “0x02” and the DE-No notified by the second-definition DE-No notification is “0x01,” the DE-No is determined to be “0x02.”

In the pattern 3, the DE-No is present in the first-definition DE-No notification but the DE-No in the second-definition DE-No notification is indefinite. Accordingly, the integration unit 37 determines the value by the first-definition DE-No notification as the DE-No. For example, when the DE-No notified by the first-definition DE-No notification is “0x01” and the DE-No notified by the second-definition DE-No notification is “0xff,” the DE-No is determined to be “0x01.” Here, the notified DE-No “0xff” indicates that the DE-No is not retrieved and is indefinite. Examples of the case where the second-definition DE-No is not notified include the case when the WWN of a DE 2 in the DE-DISK-TBL 31b is not registered, the case where a DE 2 is replaced, and the case where inactive DE 2 increase is performed.

In the pattern 4, the first-definition DE-No is not notified and the second-definition DE-No is notified. Accordingly, the integration unit 37 determines the value by the second-definition DE-No notification as the DE-No. For example, when the DE-No notified by the first-definition DE-No notification is “0xff” and the DE-No notified by the second-definition DE-No notification is “0x01,” the DE-No is determined to be “0x01.” Examples of the case where the first-definition DE-No is not notified include the case when the WWNs of the disk devices 24 are not registered in the DE-DISK-TBL 31b, the case where no disk device 24 is mounted on the DE 2, and the case where disk devices 24 in the DE 2 are replaced or moved.

In the pattern 5, both the first-definition DE-No and the second-definition DE-No are not notified and so the pertinent DE 2 is undefined. Accordingly, the integration unit 37 sends a message through a man machine interface (MMI) to prompt an administrator to define the DE 2. For example, when the DE-No notified by the first-definition DE-No notification and the DE-No notified by the second-definition DE-No notification are “0xff,” the DE-No is determined according to the connection order. Examples of the case where both the first-definition DE-No and the second-definition DE-No are not notified include the case where the storage apparatus 3 is started up for the first time and power is supplied to the storage apparatus 3 while the DE 2 and the disk devices 24 are mounted thereon, and the case where the DE 2 and the disk devices 24 are mounted without using the MMI.

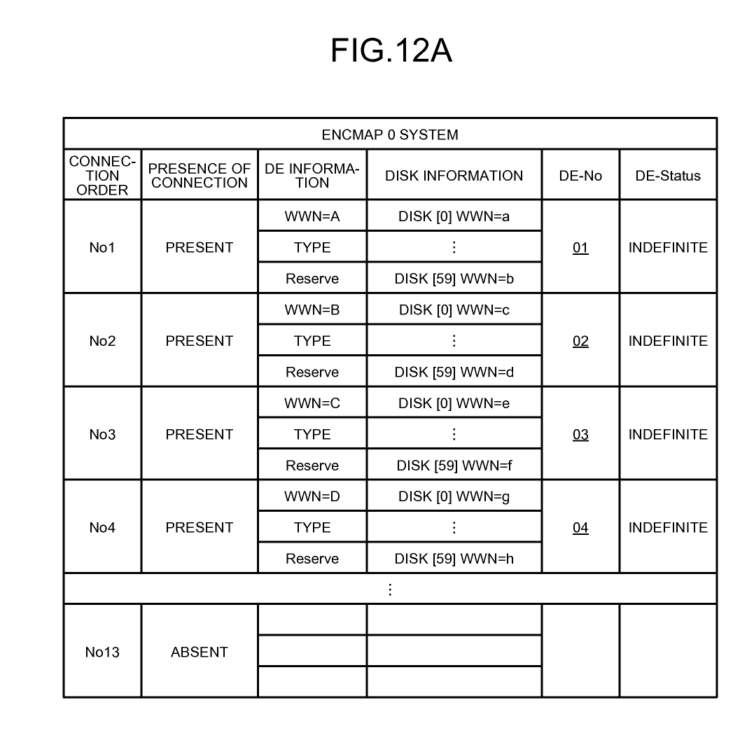

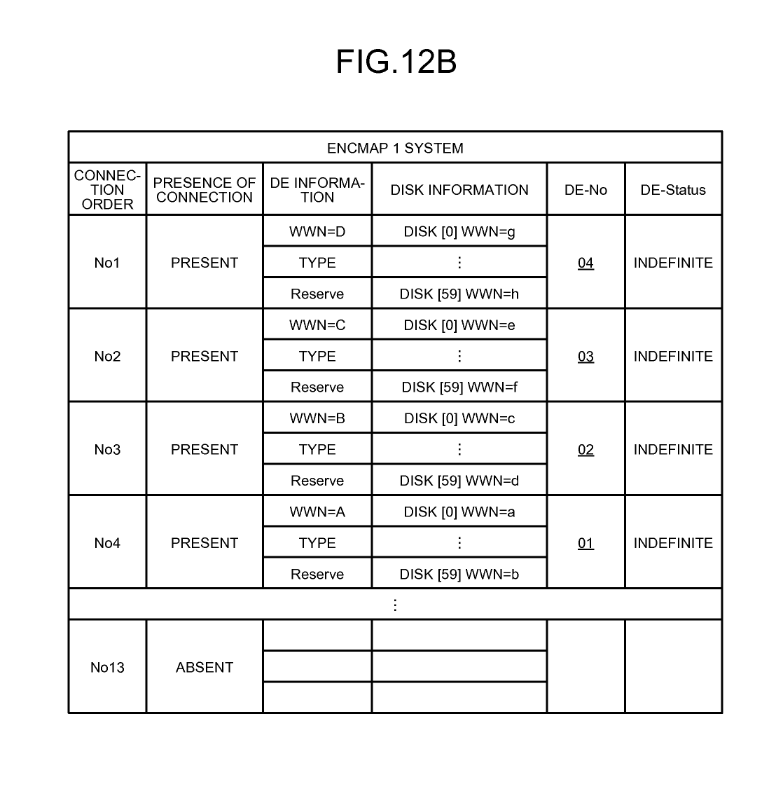

FIGS. 12A and 12B illustrate the ENCMAP 34 after DE-No determination. FIG. 12A illustrates the case of straight cable connection configuration, while FIG. 12B illustrates the case of reverse cable connection configuration.

As illustrated in FIGS. 12A and 12B, the DE-Nos determined by the integration unit 37 are stored in the ENCMAP 34. In FIG. 12A and FIG. 12B, the DE-Nos determined by the integration unit 37 are underlined.

Referring again to FIG. 4, the check unit 38 checks whether or not the order of DE-Nos in the DE-DISK-TBL 31b and the order of DE-Nos in the ENCMAP 34 are identical, so as to determine whether or not there is an incorrect cable connection. In the straight cable connection, the order of DE-Nos in the DE-DISK-TBL 31b is in ascending order, while the DE-No sequence is in descending order in the reverse cable connection. Accordingly, the check unit 38 can determine incorrect connection by checking only the order of DE-Nos in the ENCMAP 34.

The check unit 38 checks the order of DE-Nos of the respective DEs 2 in the ENCMAP 34 and stores the checking result in the DE-Status of the ENCMAP 34 as the status of the DEs 2. As the status of the DE 2, there are “ONLINE” representing a normal state, “WRONG_DE” representing incorrect connection, “LINK_DOWN” representing DE 2 disconnection, and “--” representing undefined DE 2 connection.

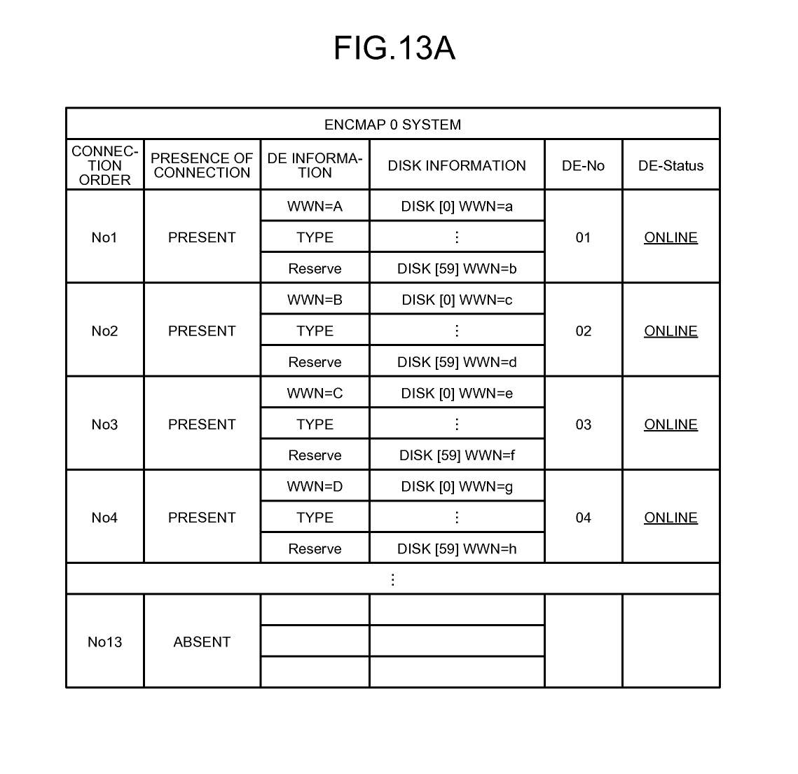

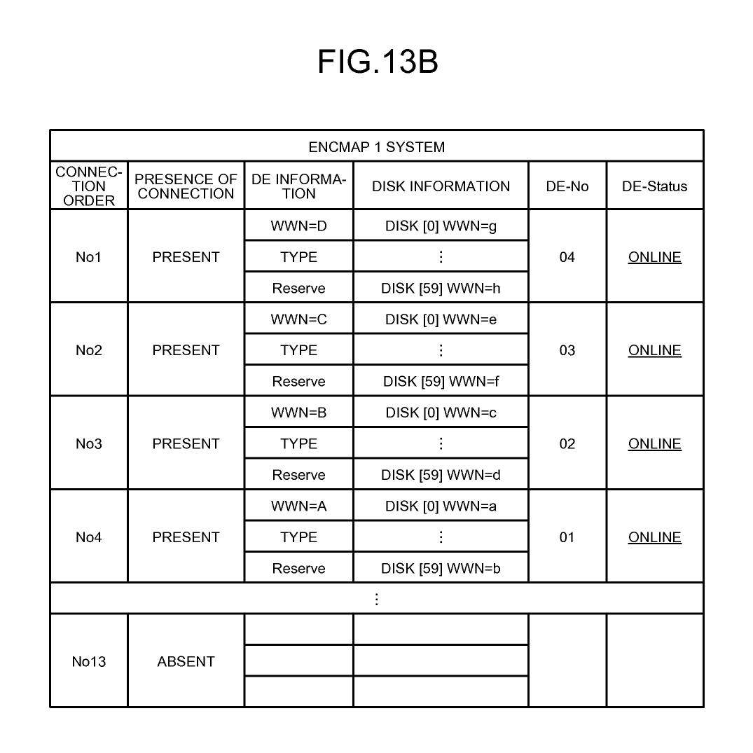

FIGS. 13A and 13B illustrate the ENCMAP 34 after DE-Status determination. FIG. 13A illustrates the case of the straight cable connection configuration, while FIG. 13B illustrates the case of the reverse cable connection configuration.

As illustrated in FIGS. 13A and 13B, “ONLINE” is stored in the DE-Status when the order of DE-Nos is correct. In FIGS. 13A and 13B, the DE 2 statuses determined by the check unit 38 are underlined.

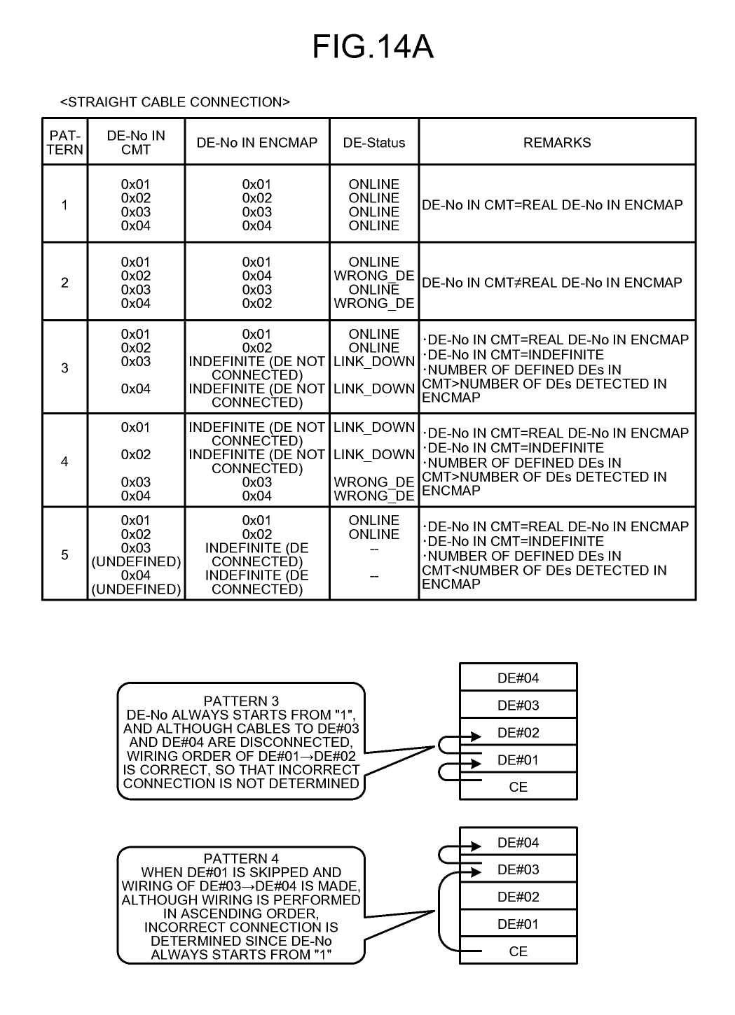

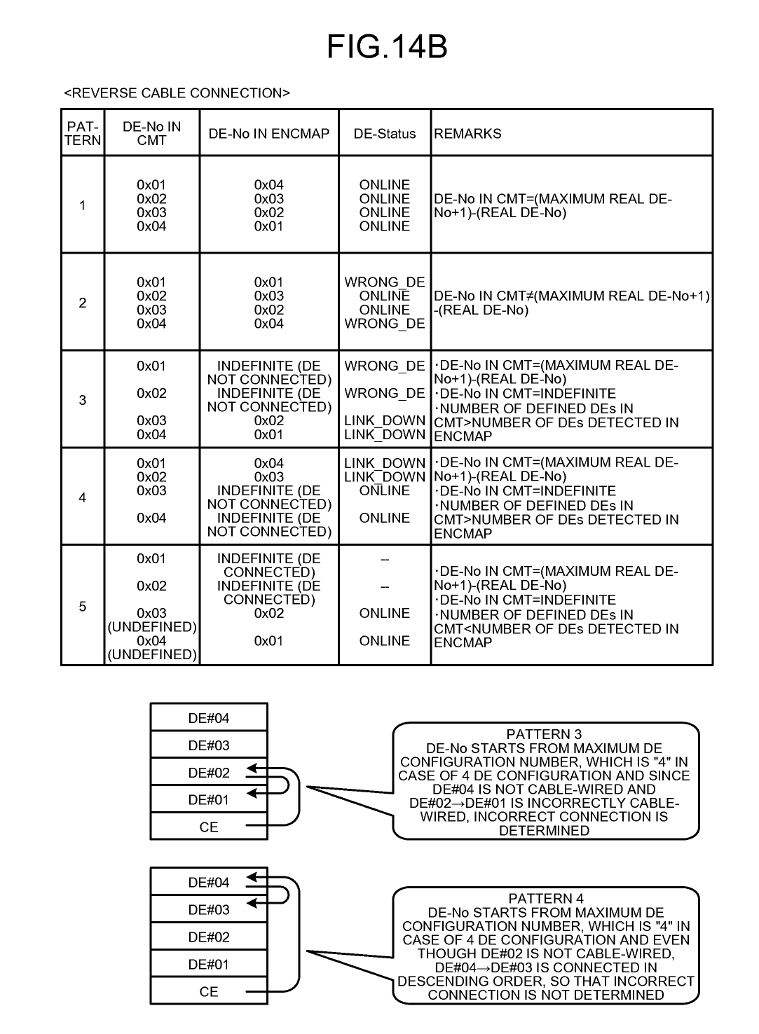

FIGS. 14A and 14B illustrate one example of DE-Status determination results. FIG. 14A illustrates the case of the straight cable connection configuration, while FIG. 14B illustrates the case of the reverse cable connection configuration. In FIGS. 14A and 14B, “pattern” represents the DE-No determination patterns illustrated in FIG. 10, and “DE-No in CMT” represents DE-No in the DE-DISK-TBL 31b.

In the patterns 1 to 5 in FIG. 14A, the DE-Status of a DE 2, whose DE-Nos in the CMT and in the ENCMAP 34 are identical, is determined to be “ONLINE.” In the pattern 2 of FIG. 14A, the DE-Status of a DE 2, whose DE-Nos in the CMT and in the ENCMAP 34 are different from each other, is determined to be “WRONG_DE.”

In the pattern 3 of FIG. 14A, the DE-No starts from “1,” and although cables to DE#03 and DE#04 are disconnected, a wiring order of DE#01→DE#02 is correct. Accordingly, the DE-Status of DE#01 and DE#02 is determined to be “ONLINE.” Meanwhile, since DE#03 and DE#04 are not connected, the DE-Status thereof is determined to be “LINK_DOWN.”

The pattern 4 of FIG. 14A relates to the case where DE#01 and DE#02 are skipped and a line of DE#03→DE#04 is wired. In this case, although wiring is performed in ascending order, the DE-No does not start from “1.” Accordingly, the DE-Statuses of DE#01 and DE#02 are determined to be “LINK_DOWN,” while the DE-Statuses of DE#03 and DE#04 are determined to be “WRONG_DE.” In the pattern 5 of FIG. 14A, two undefined DEs 2 are connected to DE#02, so that the DE-Statuses of the undefined DEs 2 are determined to be “--.”

In the patterns 1 to 5 of FIG. 14B, the DE-Status of the DE 2, whose DE-No in the CMT is identical to (maximum real DE-No+1)−(real DE-No), is determined to be “ONLINE.” Here, “real DE-No” is the DE-No of the DE 2 actually connected, i.e., the DE-No stored in the ENCMAP 34. The DE-No in the CMT is compared with (maximum real DE-No+1)−(real DE-No) because the DE-No stored in the ENCMAP 34 is in reverse order.

In the pattern 2 of FIG. 14B, the DE-Status of the DE 2, whose DE-No in the CMT is different from (maximum fruit DE-No+1)−(real DE-No), is determined to be “WRONG_DE.” In the pattern 3 of FIG. 14B, the maximum DE 2 configuration number is assumed to be “4.” Since DE#04 is not cable-connected and connection of DE#02→DE#01 is incorrectly established, the DE-Statuses of DE#01 and DE#02 are determined to be “WRONG_DE.” Meanwhile, since DE#03 and DE#04 are not connected, the DE-Statuses thereof are determined to be “LINK_DOWN.”

In the pattern 4 of FIG. 14B, the DE-No starts from “4” that is the maximum DE 2 configuration number, and DE#04→DE#03 is wired in descending order. Accordingly, the DE-Statuses of DE#03 and DE#04 are determined to be “ONLINE,” while the DE-Statuses of E#01 and DE#02 are determined to be “LINK_DOWN.” In the pattern 5 of FIG. 14B, two undefined DEs 2 are present, and DE#02 is connected to one of these DEs 2. Accordingly, the DE-Statuses of the undefined DEs 2 are determined to be “--.”

Referring again to FIG. 4, the determination unit 39 determines the status of the storage apparatus 3 on the basis of the information on the DE-Status in the ENCMAP 34. As the status of the storage apparatus 3, there are “Ready” which indicates that there is no incorrect cable connection, “NRDY16” which indicates that there is an incorrect cable connection, and “Ready (with error)” which indicates that there is no incorrect connection but unconnected DEs 2 are present.

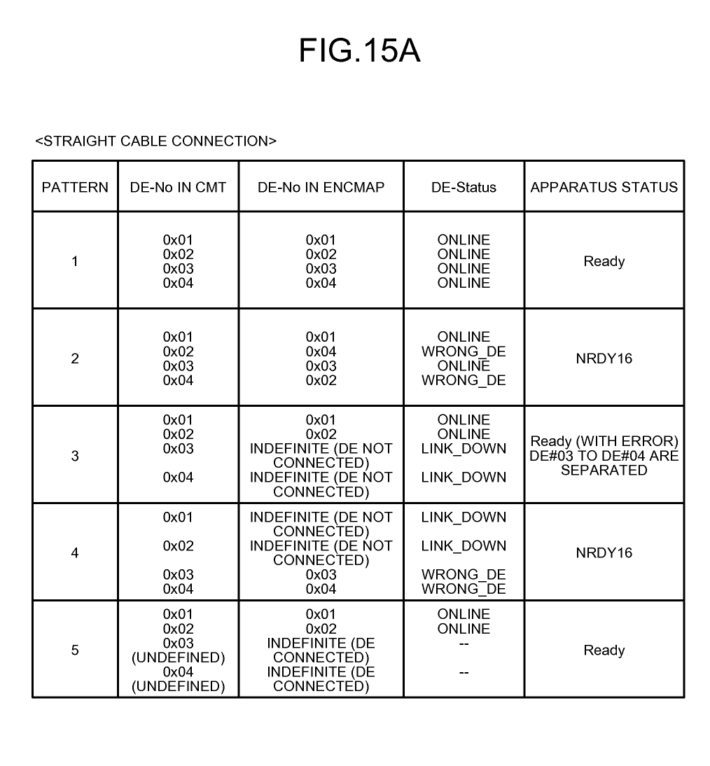

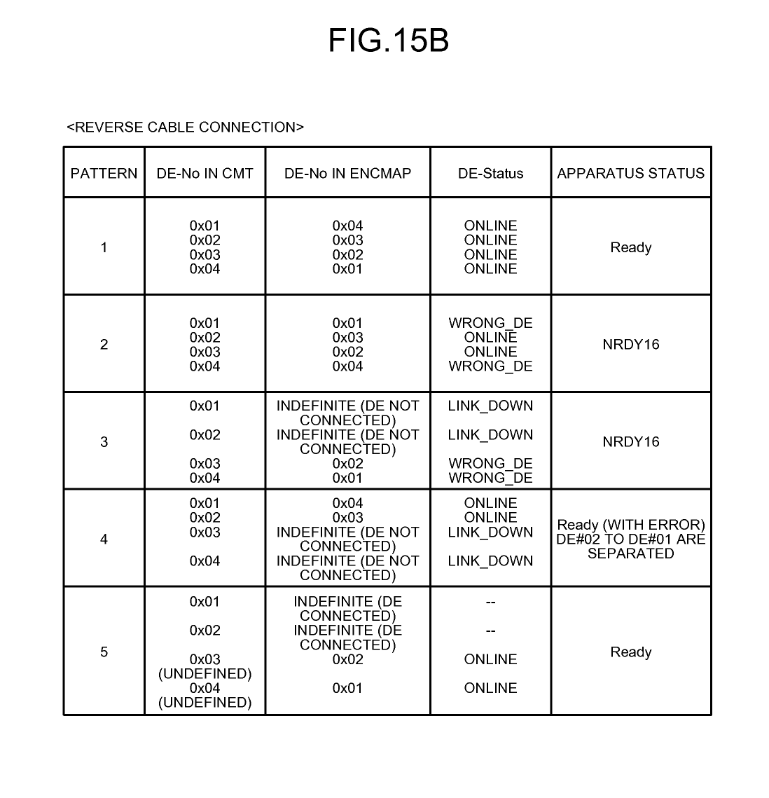

FIGS. 15A and 15B illustrate examples of apparatus status determination. FIG. 15A illustrates the case of the straight cable connection configuration, while FIG. 15B illustrates the case of the reverse cable connection configuration. In the pattern 1 of FIGS. 15A and 15B, the DE-Statuses of all the DEs are “ONLINE” and there is no incorrect connection. Accordingly, the apparatus status is determined to be “Ready.”

In the pattern 2 of FIGS. 15A and 15B, the DE-Statuses of two DEs 2 are “WRONG_DE,” so that there is an incorrect connection. Accordingly, the apparatus status is determined to be “NRDY16.” In the pattern 3 of FIG. 15A and the pattern 4 of FIG. 15B, two DEs 2 are not connected. Accordingly, the apparatus status is determined to be “Ready (with error).”

In the pattern 4 of FIG. 15A and the pattern 3 of FIG. 15B, the DE-Statuses of two DEs 2 are “WRONG_DE”, so that there is an incorrect connection. Accordingly, the apparatus status is determined to be “NRDY16.” In the pattern 5 of FIGS. 15A and 15B, two undefined DEs 2 are connected, but there is no incorrect connection. Accordingly, the apparatus status is determined to be “Ready.”

When the status of the storage apparatus 3 is “NRDY16” or “Ready (with error),” the determination unit 39 identifies an IOM 21 to be separated, and separates the identified IOM 21.

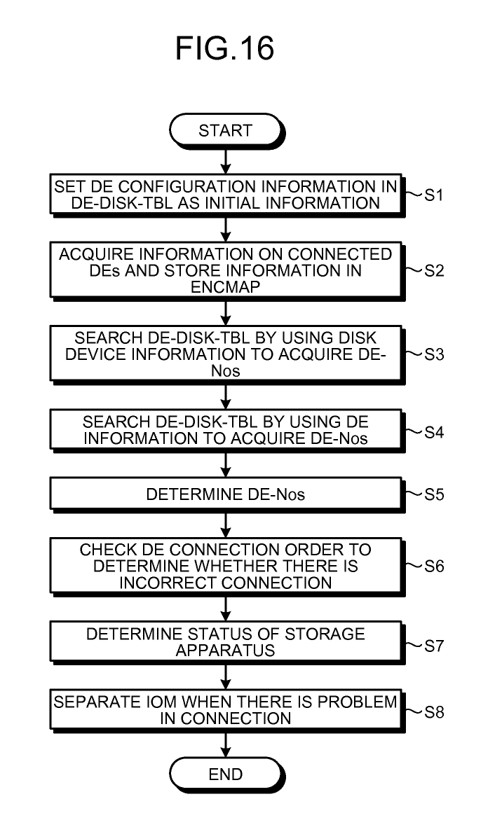

A description will now be given of a flow of apparatus status determination processing performed by the control unit 30. FIG. 16 is a flow chart illustrating the flow of apparatus status determination processing performed by the control unit 30. As illustrated in FIG. 16, when the storage apparatus 3 is turned on, the CMT management unit 32 reads out DE 2 configuration information from the BUD 20, and sets the information in the DE-DISK-TBL 31b as initial information (step S1).

Then, the acquisition unit 33 acquires information on connected DEs 2, and stores the information in the ENCMAP 34 (step S2). Then, by using information on the disk devices 24 of the DEs 2 whose information was stored in the ENCMAP 34, the member notification unit 35 searches the DE-DISK-TBL 31b to acquire DE-Nos (step S3), and notifies the integration unit 37 of the acquired DE-Nos. By using information of the DEs 2 whose information was stored in the ENCMAP 34, the class notification unit 36 searches the DE-DISK-TBL 31b to acquire DE-Nos (step S4), and notifies the integration unit 37 of the acquired DE-Nos.

On the basis of the DE-Nos notified by the member notification unit 35 and the DE-Nos notified by the class notification unit 36, the integration unit 37 determines the DE-No of each connected DE 2 (step S5). Then, the check unit 38 checks the connection order of the DEs 2 on the basis of the order of DE-Nos, and determines whether there is an incorrect connection (step S6). Then, the determination unit 39 determines the status of the storage apparatus 3 on the basis of the presence of incorrect connection (step S7). When there is a connection problem, the determination unit 39 identifies an IOM 21 to be separated, and separates the identified IOM 21 (step S8). By execution of these processing steps, the control unit 30 completes the turning-on.

Thus, since the control unit 30 checks the connection order of the DEs 2 on the basis of the configuration information stored in the DE-DISK-TBL 31b, it becomes possible to correctly determine incorrect cable connection. The control unit 30 performs processing in steps S2 to S6 for the 0 system and the 1 system.

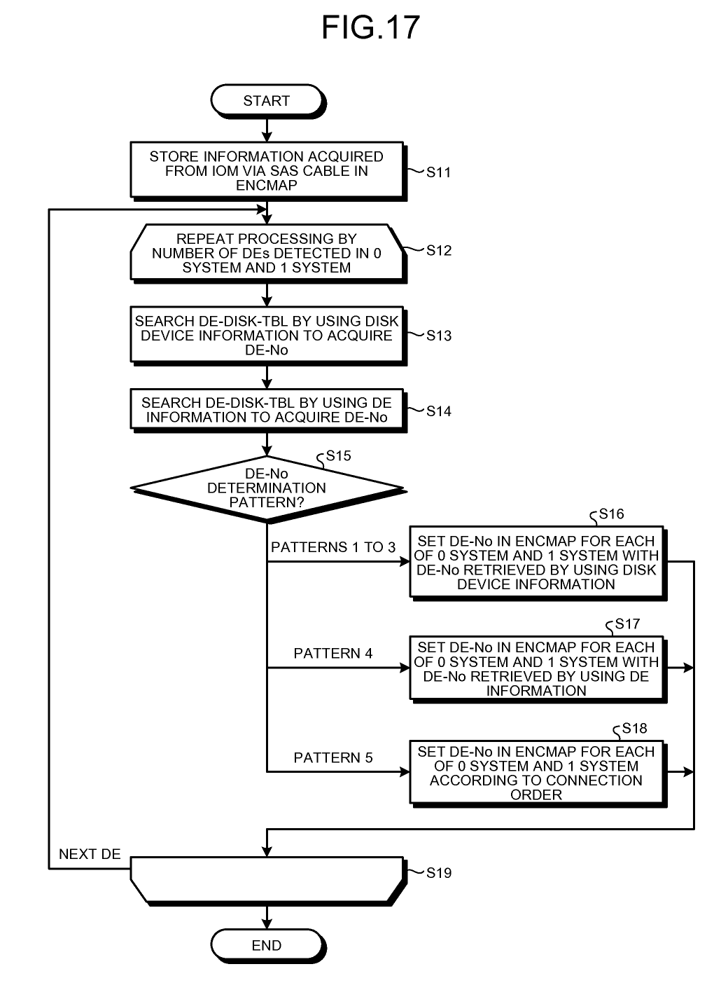

Next, the details of the processing in steps S2 to S5 illustrated in FIG. 16 will be described. FIG. 17 is a flow chart illustrating the details of the processing in steps S2 to S5 illustrated in FIG. 16.

As illustrated in FIG. 17, the acquisition unit 33 acquires information from the IOMs 21 via the SAS cable and stores the information in the ENCMAP 34 (step S11). The member notification unit 35, the class notification unit 36, and the integration unit 37 repeat the processing between step S12 and step S19 by the number of the DEs 2 detected in the 0 system and the 1 system.

Specifically, by using information on the disk devices 24 of a DE 2, the member notification unit 35 searches the DE-DISK-TBL 31b to acquire the DE-No (step S13), and notifies the integration unit 37 of the acquired DE-No. By using DE 2 information, the class notification unit 36 searches the DE-DISK-TBL 31b to acquire the DE-No (step S14), and notifies the integration unit 37 of the acquired DE-No.

On the basis of the DE-No notified by the member notification unit 35 and the DE-No notified by the class notification unit 36, the integration unit 37 determines a DE-No determination pattern (step S15).

When the DE-NO determination pattern is within the patterns 1 to 3, the integration unit 37 sets the DE-No of the ENCMAP 34 for each of the 0 system and 1 system with the DE-No retrieved by using the information on the disk devices 24 (step S16).

When the DE-NO determination pattern is the pattern 4, the integration unit 37 sets the DE-No of the ENCMAP 34 for each of the 0 system and 1 system with the DE-No retrieved by using the DE 2 information (step S17).

When the DE-NO determination pattern is the pattern 5, the integration unit 37 sets the DE-No in the ENCMAP 34 for each of the 0 system and 1 system in the connection order (step S18).

Thus, since the integration unit 37 sets the DE-Nos of the ENCMAP 34 on the basis of the DE-Nos notified by the member notification unit 35 and the DE-Nos notified by the class notification unit 36, it becomes possible to correctly set the DE-Nos of the ENCMAP 34.

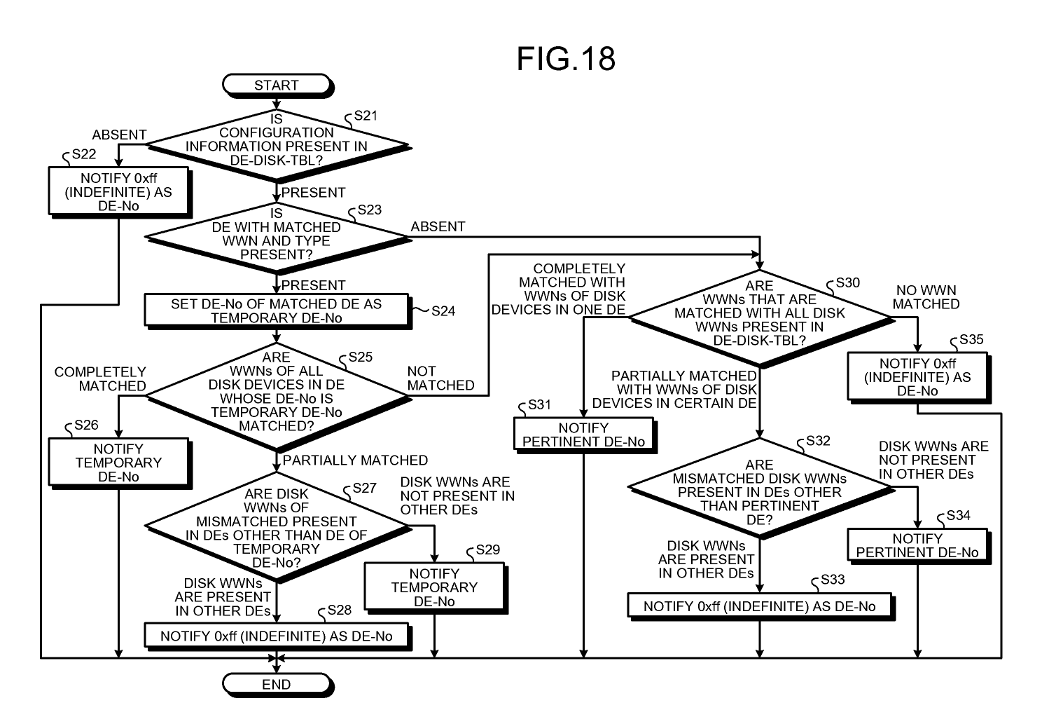

Now, a flow of processing to acquire a DE-No from the information on the disk devices 24 will be described. FIG. 18 is a flow chart illustrating the flow of processing to acquire the DE-No from the information on the disk device 24.

As illustrated in FIG. 18, the member notification unit 35 determines whether or not configuration information is present in the DE-DISK-TBL 31b (step S21). If the configuration information is not present, the member notification unit 35 notifies the integration unit 37 of 0xff which indicates that the configuration information is indefinite (step S22).

If the configuration information is present, the member notification unit 35 determines whether or not a DE 2, whose WWN and type are matched with specified WWN and type, is present in the DE-DISK-TBL 31b (step S23). When the DE 2 is present, the member notification unit 35 sets the DE-No of the DE 2, whose WWN and type are matched, as a temporary DE-No (step S24). Then, the member notification unit 35 determines whether or not WWNs of all the disk devices 24 in the DE 2, whose DE-No is set as the temporary DE-No, are matched with all the WWNs specified as a search key (step S25).

As a result, when all the WWNs are matched, the member notification unit 35 notifies the integration unit 37 of the temporary DE-No (step S26). When the WWNs are partially matched, the member notification unit 35 determines whether or not mismatched disk WWNs are present in the DEs 2 other than the DE 2 whose DE-No is the temporary DE-No (step S27). Here, the disk WWNs refer to the WWNs of the disk devices 24. As a result, when the disk WWNs are present in another DE 2, the member notification unit 35 notifies the integration unit 37 of 0xff which indicates that the DE-No is indefinite (step S28). When the disk WWNs are not present in other DEs 2, the member notification unit 35 notifies the integration unit 37 of the temporary DE-No (step S29).

When the matched WWN is not present or when the DE 2 whose WWN and type are matched is not present in the DE-DISK-TBL 31b, the member notification unit 35 determines whether or not WWNs that are matched with all the disk WWNs are present in the DE-DISK-TBL 31b (step S30). As a result, when all the WWNs of disk devices 24 in one DE 2 are matched, the member notification unit 35 notifies the integration unit 37 of the pertinent DE-No (step S31). More specifically, the member notification unit 35 notifies the integration unit 37 of the DE-No of the DE 2 which houses the disk devices 24 whose WWNs are matched with all the WWNs.

When the WWNs are partially matched with WWNs of the disk devices 24 in a certain DE 2, the member notification unit 35 determines whether or not mismatched disk WWNs are present in other DEs 2 (step S32). As a result, when the disk WWNs are present in other DEs 2, the member notification unit 35 notifies the integration unit 37 of 0xff that indicates that the DE-No is indefinite (step S33). When the disk WWNs are not present in other DEs 2, the member notification unit 35 notifies the integration unit 37 of the pertinent DE-No (step S34). More specifically, the member notification unit 35 notifies the integration unit 37 of the DE-No of the DE 2 which houses the disk devices 24 whose WWNs are partially matched. When no WWN in the DE-DISK-TBL 31b is matched, the member notification unit 35 notifies the integration unit 37 of 0xff that indicates that the DE-No is indefinite (step S35).

Thus, the member notification unit 35 can acquire the DE-No by searching the DE-DISK-TBL 31b with use of the disk WWNs.

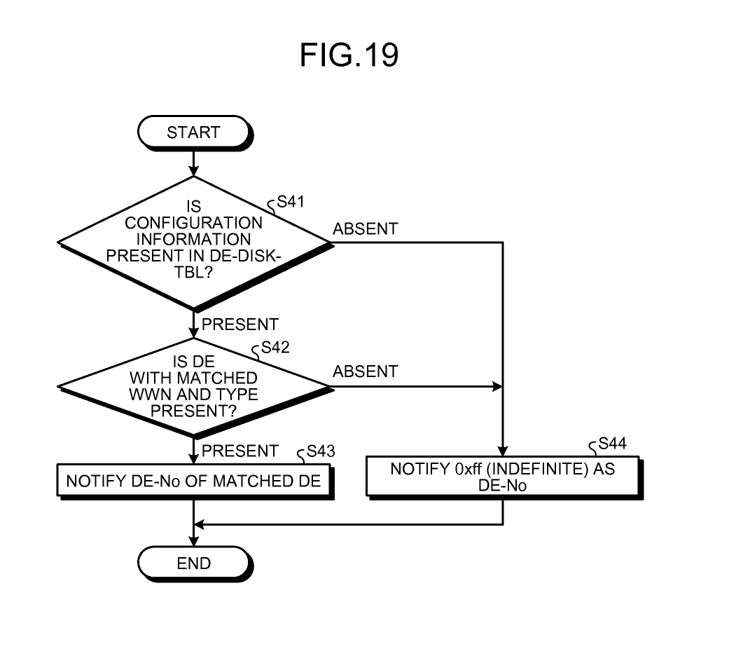

Next, a flow of processing to acquire a DE-No from the DE 2 information will be described. FIG. 19 is a flow chart illustrating the flow of processing to acquire the DE-No from the DE 2 information. As illustrated in FIG. 19, the class notification unit 36 determines whether or not configuration information is present in the DE-DISK-TBL 31b (step S41). If the configuration information is not present, the class notification unit 36 notifies the integration unit 37 of 0xff which indicates that the DE-No is indefinite (step S44).

If the configuration information is present, the class notification unit 36 determines whether or not the DE 2, whose WWN and type are matched with the WWN and type specified by a search key, is present in the DE-DISK-TBL 31b (step S42). As a result, when the DE 2 is present, the class notification unit 36 notifies the integration unit 37 of the DE-No of the DE 2 whose WWN and type are matched with the specified WWN and type (step S43). When the DE 2 is not present, the class notification unit 36 notifies the integration unit 37 of 0xff which indicates that the DE-No is indefinite (step S44).

Thus, the class notification unit 36 can acquire the DE-No by searching the DE-DISK-TBL 31b by using the WWN and type of the DE 2.

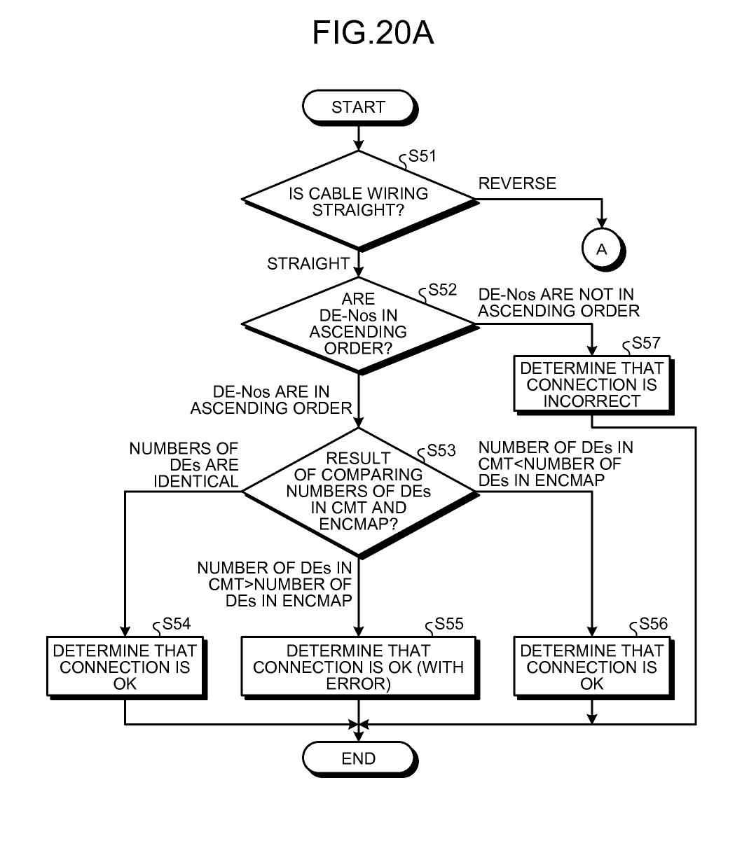

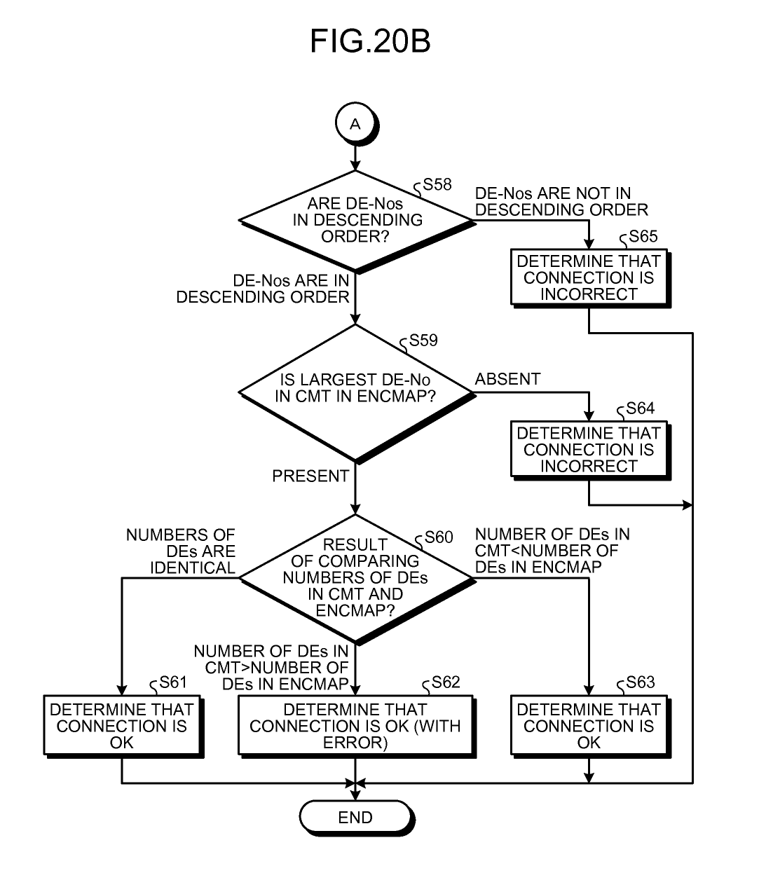

Next, a flow of connection check processing will be described. FIGS. 20A and 20B are flow charts illustrating flows of connection check processing. The check unit 38 performs the processing illustrated in FIGS. 20A and 20B for each of the 0 system and the 1 system.

As illustrated in FIG. 20A, the check unit 38 determines whether or not cable wiring is straight on the basis of a value of SubsysMode#21 in the subsystem mode TBL31a (step S51). As a result, when the cable wiring is straight, the check unit 38 determines whether or not the DE-Nos of the ENCMAP 34 are in ascending order (step S52).

As a result, when the DE-Nos are in ascending order, the check unit 38 compares the numbers of DEs in the CMT 31 and in the ENCMAP 34, and makes a determination according to the comparison result (step S53). Here, the number of DEs in the CMT 31 is the number of the DEs 2 stored in the DE-DISK-TBL 31b.

When the numbers of the DEs are identical, the check unit 38 determines that the connection is OK (step S54). When the number of DEs in the CMT 31 is larger than the number of DEs in the ENCMAP 34, the connection is determined to be OK, though an error is present (step S55). The number of DEs in the CMT 31 becomes larger than the number of DEs in the ENCMAP 34 when DE 2 information is not acquired by the acquisition unit 33 due to failures of the IOM 21, cable disconnection, and the like.

When the number of DEs in the CMT 31 is smaller than the number of DEs in the ENCMAP 34, the check unit 38 determines that connection is OK (step S56). The number of DEs in the CMT 31 becomes smaller than the number of DEs in the ENCMAP 34 when inactive DE 2 increase is performed. When the DE-Nos are not in ascending order, the check unit 38 determines that connection is incorrect (step S57).

In the case of reverse cable wiring, the check unit determines whether or not the DE-Nos in the ENCMAP 34 are in descending order as illustrated in FIG. 20B (step S58). As a result, if the DE-Nos are in descending order, the check unit 38 determines whether or not the largest DE-No in the CMT 31 is present in the ENCMAP 34 (step S59). If the largest DE-No is present in the ENCMAP 34, the check unit 38 compares the numbers of the DEs in the CMT 31 and in the ENCMAP 34, and makes a determination according to the comparison result (step S60).

When the numbers of DEs are identical, the check unit 38 determines that connection is OK (step S61), whereas when the number of DEs in the CMT 31 is larger than the number of DEs in the ENCMAP 34, the check unit 38 determines that connection is OK though an error is present (step S62). When the number of DEs in the CMT 31 is smaller than the number of DEs in the ENCMAP 34, the check unit 38 determines that connection is OK (step S63). When the largest DE-No in the CMT 31 is not in the ENCMAP 34, the check unit 38 determines that connection is incorrect (step S64). When the DE-Nos are not in descending order, the check unit 38 determines that connection is incorrect (step S65).

Thus, the check unit 38 checks cable connection on the basis of the order of DE-Nos stored in the ENCMAP 34 by the integration unit 37, so that cable connection can correctly be checked.

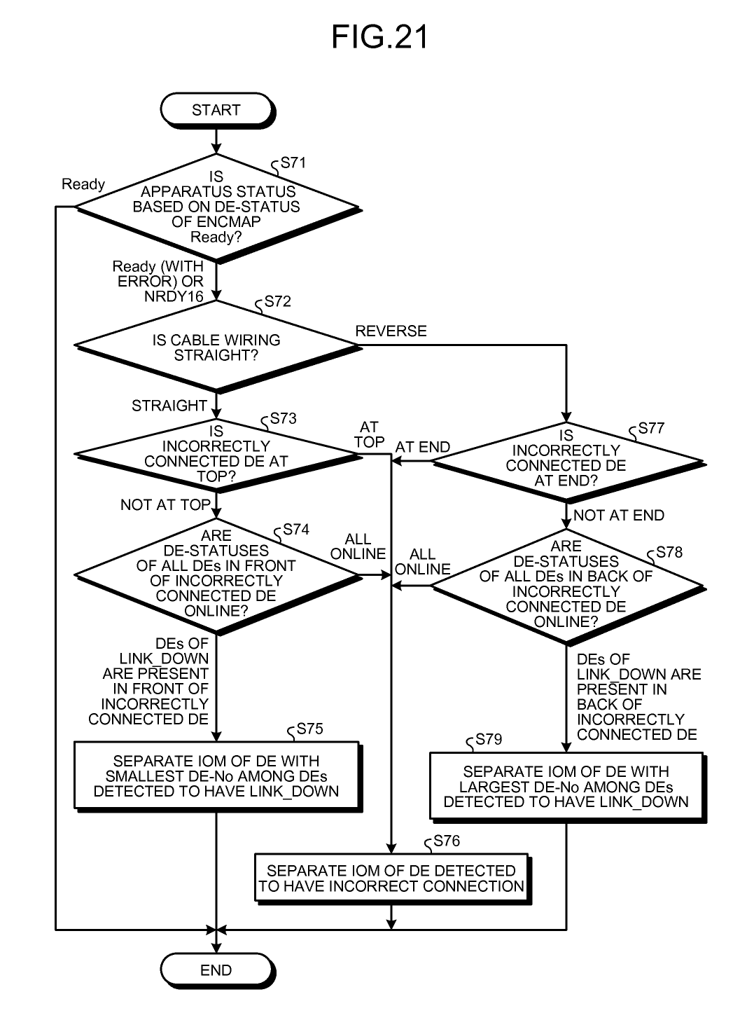

Next, a flow of IOM 21 separation processing will be described. FIG. 21 is a flow chart illustrating the flow of IOM 21 separation processing. As illustrated in FIG. 21, the determination unit 39 determines whether or not the status of the apparatus based on the DE-Status in the ENCMAP 34 is Ready (step S71). As a result, when the status is Ready, connection of the storage apparatus 3 is correct, so that the determination unit 39 ends the processing without performing separation of the IOM 21.

Contrary to this, when the status of the apparatus is not Ready, i.e., when the status of the apparatus is Ready (with error) or NRDY16, the determination unit 39 determines whether or not the cable wiring is straight (step S72). As a result, when the cable wiring is straight, the determination unit 39 determines whether the incorrectly connected DE 2 (WRONG_DE) is at the top (step S73). When the incorrectly connected DE 2 is not at the top, the determination unit 39 determines whether or not the DE-Statuses of all the DEs 2 in front of the incorrectly connected DE 2 are ONLINE (step S74).

As a result, when any LINK_DOWN DE 2 is present in front of the incorrectly connected DE 2, the determination unit 39 separates the IOM 21 of a DE 2, which has the smallest DE-No among the DEs 2 detected to have LINK_DOWN (step S75). When the DE-Statuses of all the DEs 2 in front of the incorrectly connected DE 2 are ONLINE, or when the incorrectly connected DE 2 is at the top, the determination unit 39 separates the IOM 21 of the incorrectly connected DE 2 (step S76).

In the case of reverse cable wiring, the determination unit 39 determines whether or not the incorrectly connected DE 2 is at the end (step S77). When the incorrectly connected DE 2 is not at the end, the determination unit 39 determines whether or not the DE-Statuses of all the DEs 2 in back of the incorrectly connected DE 2 are ONLINE (step S78).

As a result, when any LINK_DOWN DE 2 is present in back of the incorrectly connected DE 2, the determination unit 39 separates the IOM 21 of a DE 2, which has the largest DE-No among the DEs 2 detected to have LINK_DOWN (step S79). When the DE-Statuses of all the DEs 2 in back of the incorrectly connected DE 2 are ONLINE, or when the incorrectly connected DE 2 is at the end, the determination unit 39 separates the IOM 21 of the incorrectly connected DE 2 (step S76).

Thus, since the determination unit 39 identifies the IOM 21 to be separated and separates the identified IOM 21, it becomes possible to prompt the administrator to perform correct wiring.

As described in the foregoing, in the embodiment, the DE-DISK-TBL 31b in the CMT 31 stores the configuration information on the storage apparatus 3, and the acquisition unit 33 acquires the information on the connected DEs 2 and disk devices 24, and stores the information in the ENCMAP 34. Then, the member notification unit 35 acquires DE-Nos from the DE-DISK-TBL 31b by using as a search key the information about the disk devices 24 stored in the ENCMAP 34. The class notification unit 36 acquires DE-Nos from the DE-DISK-TBL 31b by using as a search key the information on the DEs 2 stored in the ENCMAP 34. Then, the integration unit 37 determines the DE-Nos of the connected DEs 2 on the basis of the DE-Nos acquired by the member notification unit 35 and the class notification unit 36. The check unit 38 determines whether or not cable connection is incorrect on the basis of the DE-Nos determined by the integration unit 37. Therefore, the control unit 30 can correctly determine incorrect cable connection on the basis of the configuration information.

Moreover, in the embodiment, the subsystem mode TBL31a of the CMT 31 stores the information on the cable connection configuration, and the check unit 38 determines whether the cable connection is straight or reverse on the basis of the information in the subsystem mode TBL31a. Then, the check unit 38 determines incorrect cable connection on the basis of whether the cable connection is straight or reverse. Therefore, the control unit 30 can correctly determine incorrect connection also in the case of the reverse cable connection.

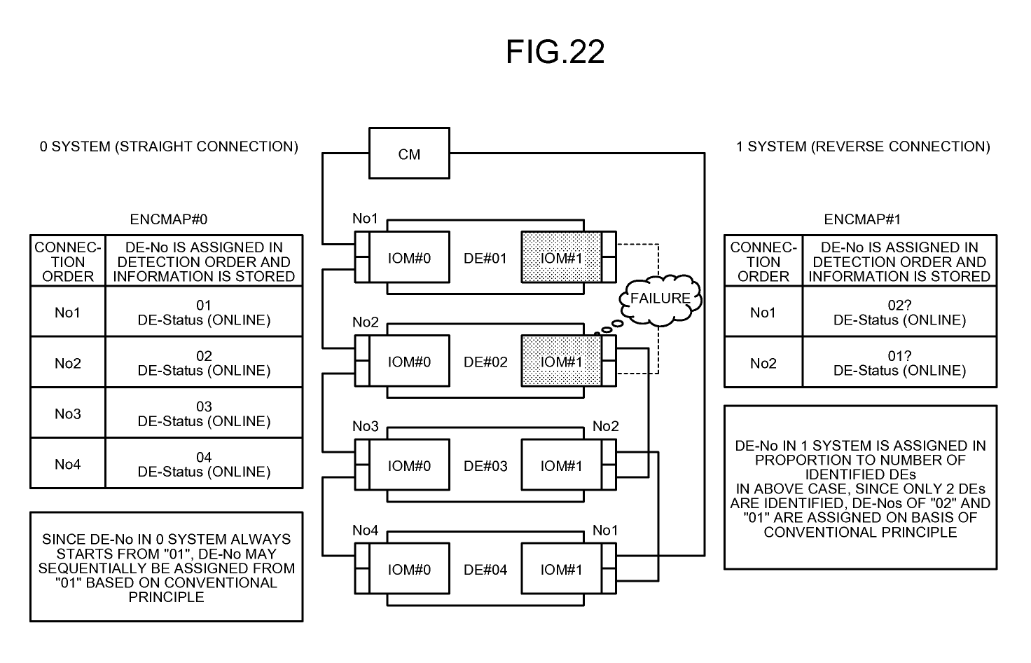

FIG. 22 illustrates a problem in a conventional connection check. In the conventional storage apparatus, the DE-Nos are assigned to connected DEs in order of detection. Therefore, as illustrated in the 0 system in FIG. 22, when cables are correctly connected in straight connection, the storage apparatus can correctly assign the DE-Nos. However, when DE#02 and DE#01 are not connected in the case of reverse connection as illustrated in the 1 system of FIG. 22, “02” is assigned to DE#04 and “01” is assigned to DE#03 since the storage apparatus assigns the DE-Nos to the connected DEs in order of detection. Therefore, the storage apparatus fails to assign correct DE-Nos. Contrary to this, the storage apparatus 3 according to the embodiment can correctly identify the DE-Nos of failed DEs 2 even when cable connection is a reverse connection.

In the embodiment, a description has been given of the case where the control unit 30 checks incorrect cable connection when the storage apparatus 3 is turned on. However, the control unit 30 can also check incorrect cable connection when active DE 2 increase and decrease is performed. Accordingly, a flow of processing for active DE 2 increase and decrease will be described.

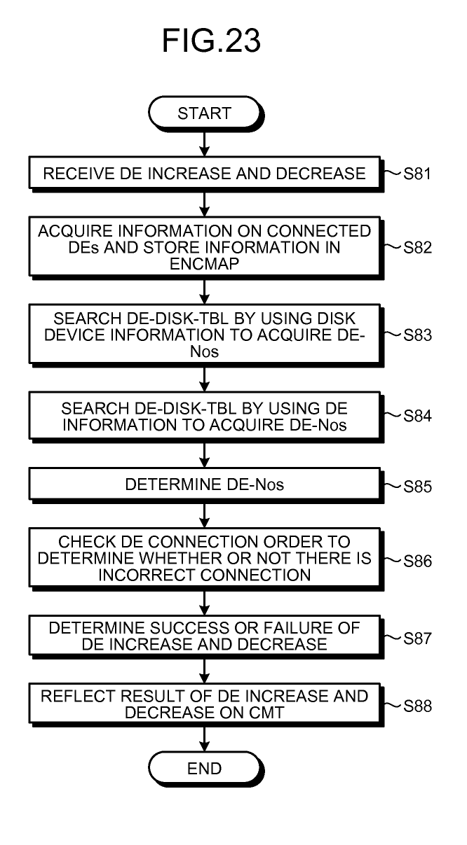

FIG. 23 is a flow chart illustrating a flow of processing for active DE 2 increase and decrease. As illustrated in FIG. 23, an MMI unit receives DE2 increase and decrease (step S81), and the acquisition unit 33 acquires information on the connected DEs 2, and stores the information in the ENCMAP 34 (step S82). Here, the MMI unit provides a man machine interface which receives an instruction from the administrator of the storage apparatus 3.

Then, by using information on the disk devices 24 of the DEs whose information was stored in the ENCMAP 34, the member notification unit 35 searches the DE-DISK-TBL 31b to acquire DE-Nos (step S83), and notifies the integration unit 37 of the acquired DE-Nos. By using information on the DEs 2 whose information was stored in the ENCMAP 34, the class notification unit 36 searches the DE-DISK-TBL 31b to acquire DE-Nos (step S84), and notifies the integration unit 37 of the acquired DE-Nos.

Then, on the basis of the DE-Nos notified by the member notification unit 35 and the DE-Nos notified by the class notification unit 36, the integration unit 37 determines the DE-No of each connected DE 2 (step S85). Then, the check unit 38 checks the connection order of the DEs 2 on the basis of the order of DE-Nos, and determines whether there is an incorrect connection (step S86). Then, the determination unit 39 determines success or failure of DE increase and decrease on the basis of the presence of incorrect connection (step S87). Then, the MMI unit reflects the result of the DE increase and decrease on the CMT 31 (step S88). Thus, active increase and decrease is completed.

As described in the foregoing, the control unit 30 can check incorrect cable connection also in the case of the active DE 2 increase and decrease.

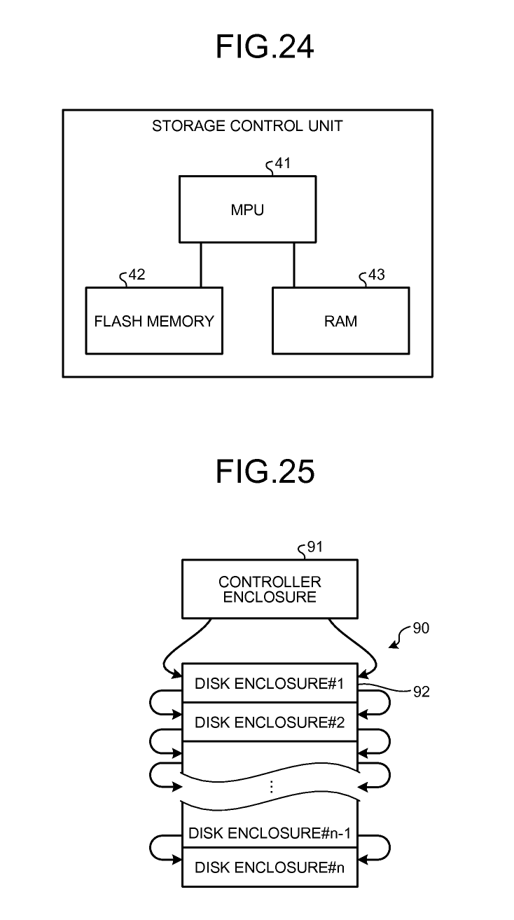

The functions of the control unit 30 are implemented by firmware. Accordingly, a description is given of a hardware configuration of the storage control unit that executes the firmware. FIG. 24 illustrates the hardware configuration of the storage control unit. As illustrated in FIG. 24, the storage control unit includes an MPU 41, a flash memory 42, and a RAM 43.

The MPU 41 is a processing device that reads out a program from the RAM 43 and executes the program. The flash memory 42 is a nonvolatile memory that stores programs. A program stored in the flash memory 42 is temporarily written in the RAM 43, and the MPU 41 reads out the program from the RAM 43 and executes the program. The RAM 43 is a memory that stores programs, program intermediate results, and the like.

In the embodiment, a description has been given of the case where the DE-DISK-TBL 31b stores the information on the DEs 2 in connection order of the DEs 2 which are connected in ascending order. However, the present invention is not limited thereto, and the present invention is also applicable to the case where, for example, the DE-DISK-TBL 31b stores the information on the DEs 2 in other orders, such as in the case where the DEs 2 are connected in descending order. In that case, the check unit 38 determines incorrect cable connection not by checking whether the DE-Nos are in ascending order or the descending order, but by checking whether the order of DE-Nos is according to a storage order of the DEs 2 which are stored in the DE-DISK-TBL 31b.

In the embodiment, although a description has been given of the case where each of the DEs 2 houses the plurality of disk devices 24, the present invention is not limited thereto. The present invention is also applicable to the case where, for example, each of the DEs 2 houses other drive devices, such as solid state drives (SSDs).

According to one embodiment, it becomes possible to correctly detect incorrect cable connection.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage controller that controls a plurality of enclosures connected in cascade, comprising:
a memory that stores information that defines the enclosures; and
a processor that acquires information on the connected disk enclosures from the enclosures, identifies connected storage devices on the basis of the acquired information and the information stored in the memory, and determines whether or not the identified enclosures are correctly connected on the basis of a connection order of the enclosures.

2. The storage controller according to claim 1, wherein
the memory further stores direction information indicating whether the cascade connection is in a forward direction or in a backward direction, and
the processor determines whether or not the enclosures are correctly connected on the basis of the direction information.

3. The storage controller according to claim 1, wherein
each of the enclosures houses a plurality of drive devices,
the memory stores the information that defines the enclosures and information that defines the plurality of drive devices, and
the processor acquires from the connected enclosures, the information on the enclosures and the information on the drive devices connected via the enclosures, and identifies the connected enclosures on the basis of the information that defines the enclosures and the information on the enclosure, or the information that defines the drive devices and the information on the drive devices.

4. The storage controller according to claim 3, wherein
when a first identification result of identifying an enclosure on the basis of the information that defines the drive devices and the information on the drive devices is different from a second identification result of identifying the enclosures on the basis of the information that defines the enclosures and the information on the enclosures, the processor sets the first identification result as an identification result.

5. A storage apparatus, comprising:
a plurality of enclosures connected in cascade; and
a storage controller that controls the plurality of enclosures, wherein
the storage controller includes:
a memory that stores information that defines the enclosures; and
a processor that acquires information on the connected enclosures from the enclosures, identifies connected storage devices on the basis of the acquired information and the information stored in the memory, and determines whether or not the identified enclosures are correctly connected on the basis of a connection order of the enclosures.

6. A computer-readable storage medium having stored a storage control program causing a computer to execute a process, the computer being included in a storage controller that controls a plurality of enclosures connected in cascade, the process comprising:
storing information that defines the enclosures in a memory;
acquiring information on the connected enclosures from the enclosures;
identifying connected storage devices on the basis of the acquired information and the information stored in the memory; and
determining whether or not the identified enclosures are correctly connected on the basis of a connection order of the enclosures.
